(19) United States
(12) Patent Application Publication
(10) Pub. No.: US 2008/0184783 A1
(43) Pub. Date: Aug. 7, 2008

(54) Test tee

(75) Inventor: Steven Chromey, Montgomery, AL (US)

Correspondence Address: WILLIAM S RAMSEY, ESQ, 5253 EVEN STAR PLACE, COLUMBIA, MD, 21044, US

(73) Assignee: Jay R. Smith Manufacturing Company, Montgomery, AL (US)

(21) Appl. No.: 11/702,983

(22) Filed: Feb. 6, 2007

(51) Int. Cl. G01M 3/04

(52) U.S. Cl. 73/49.5

(57) ABSTRACT

An exemplary embodiment providing one or more improvements includes a piping system including a test tee, the test tee comprised of a cleanout tee having an access port, a plug for the access port, a chamber, a test plug which can be inserted into the chamber and removably attached at the top of the chamber thereby blocking the lumen of the test tee. A test port is located in the test tee above the test plug, and a nipple with a valve and a spigot with connections for a hose is inserted into the test port. In testing the integrity of the piping system, the test plug is inserted through the access port into the chamber and is attached at the top of the chamber, thereby closing the lumen of the system. Other drains in the system are closed, and water is inserted into the system, optionally through the nipple. After the integrity of the system is determined, the water is drained from the system through the nipple, the test plug is removed from the chamber, and the access port plug is replaced. Optionally, the nipple may be replaced by a test port plug until it is desired to test the integrity of the piping system again.

### CROSS-REFERENCE(S)

Not Applicable.

### STATEMENT REGARDING FEDERALLY SPONSORED RESEARCH OR DEVELOPMENT

Not Applicable.

### REFERENCE TO A “MICROFICHE APPENDIX”

Not Applicable.

### BACKGROUND

### Description of Related Art Including Information Disclosed Under 37 CFR 1.97 AND 37 CFR 1.98

Embodiments of this application relate to systems for hydrostatically determining the integrity of piping systems, in some cases, drainage, waste, and vent piping.

In some cases, it is desirable to hydrostatically test piping from one to three floors above a cleanout tee. This may involve from 10 feet of head pressure (approximately 5 pounds per square inch) to 30 feet of heat pressure (approximately 15 pounds per square inch).

One conventional method uses an air inflatable plug to block the piping. All openings in the system above the plug are closed. The piping system is then filled with water and observed for leakage. Inflatable plugs are difficult to install with integrity, are expensive, and must be discarded after only 2 or 3 uses. In addition, the release of air from an inflatable plug causes sudden release of water along with a safety hazard.

U.S. Pat. No. 4,763,510 discloses a test tee with an opening on the side for inserting and removing the sealing element. The sealing element is made of polymer and is pierced in order to drain the system after the test is completed. A screwdriver is then used to break out the sealing element.

U.S. Pat. No. 5,287,730 discloses a leakage test apparatus which uses a slidable plate to seal the pipe. A port which communicates with an inlet pipe or hose is located above the slidable plate.

U.S. Pat. No. 5,495,750 discloses a hydroscopic testing machine in which inflatable seals are used to seal the pipes being tested.

U.S. Pat. No. 6,085,363 discloses a fitting which uses a flexible baffle to seal the pipe. The baffle is permanently removed after testing is complete.

U.S. Pat. No. 6,351,985 discloses a testing apparatus which uses an inflatable bladder to seal the pipe.

U.S. Pat. No. 6,912,890 discloses a test tee filing device comprising a one-way valve to which a source of water is connected.

U.S. Pat. No. 6,935,380 discloses an end cap adaptable to two different sized pipes which has an accommodation for an inlet pipe in the center of the end cap.

U.S. Publ. Pat. Applic. No. 2001/0035223 discloses an end cap with a test fitting in the center of the end cap.

The prior art does not disclose a test tee which is permanently installed in the piping system and allows easy and reversible blocking of the system lumen and easy introduction and removal of water during the test, and, optionally, allows observation of the water level from the test tee.

The foregoing examples of the related art and limitations related therewith are intended to be illustrative and not exclusive. Other limitations of the related art will become apparent to those of skill in the art upon a reading of the specification and a study of the drawings.

### BRIEF SUMMARY

The following embodiments and aspects thereof are described and illustrated in conjunction with systems, tool and methods which are meant to be exemplary and illustrative, not limiting in scope. In various embodiments, one or more of the above-described problems have been reduced or eliminated, while other embodiments are directed to other improvements.

A hydrologic test tee comprises a cleanout tee having an access port located on the side of the tee which provides access to a chamber, an access port plug, and attachment facilities located on the internal surface of the tee at the top of the chamber above the access port. This embodiment also provides facilities to install a test plug capable of reversible interaction with these facilities, the test plug capable of blocking the lumen of the piping system. A test port is located on the tee above the test plug.

Another embodiment is the process of hydrologic testing of a piping system using a hydrologic test tee comprising the steps of removing the access port plug, inserting a test plug into the chamber, interacting the test plug with attachment facilities on the internal surface test tee at the top of the chamber, the access plug blocking the lumen of the piping and sealing the piping system at the test tee, closing drains located above the test tee, filling the piping above the test plug with water to the highest point in the piping system, observing the integrity of the system for a predetermined period of time, draining the water out of the piping, removing the test plug from the lumen of the piping and from the chamber, and replacing the access port plug.

In addition to the exemplary aspects and embodiments described above, further aspects and embodiments will become apparent by reference to the drawings and by study of the following descriptions.

### BRIEF DESCRIPTION OF THE DRAWINGS

FIG. 1 is a perspective view of one embodiment of an embodiment test tee.

FIG. 2 is a perspective view of a partial section of an embodiment test tee.

FIG. 3 is a cross section of an embodiment test tee taken at line 3-3 of FIG. 1 but with access port plug and test port plug in place.

FIG. 4 is a cross section of a second embodiment test tee.

FIG. 5 is a diagrammatic depiction of the process of using an embodiment test tee to determine the integrity of a piping system.

### DETAILED DESCRIPTION

It is necessary to test the integrity of piping systems after installation and periodically during use of the system. Test procedures for drainage, waste, and vent piping involve blocking the lumen of the piping system, plugging any installed openings, such as drains, and filling the system with water. It is typical to test piping systems extending for one to three floors above the test position, which involves head pressure of 10 feet (approximately 5 psi) to 30 feet (approximately 15 psi). If the water level does not drop after a predetermined length of time, commonly 15 minutes, the system is considered to have integrity. A drop in water level indicates a leak in the system which must be repaired.

Methods of testing the integrity of piping systems differ primarily in the method of blocking the lumen of the system. In some methods a slidable test plate is inserted between two fittings in the system for the test and is then removed after the test. This system necessarily includes sealing members involving elastomeric O-rings and therefore is subject to leaks.

A common method involves introduction into the system through a cleanout port of an inflatable balloon seal or plug which, when inflated with air, blocks the lumen of the system. Difficulties with balloon seals commonly occur when the seal is unable to retain the pressure of the water during the test and is ruptures or leaks, sometimes creating a safety hazard. This requires redoing the entire test. In addition, the balloons sometimes lodge in the pipe system and are difficult or impossible to locate and remove. Finally, balloon seals are subject to damage in the pipe system and have to be replaced at frequent intervals, after as few as two or three uses.

Embodiments of test tees have many elements in common with a cleanout tee. Both a test tee and a cleanout tee are designed as permanent features of piping systems and both have a port with a port plug. In both a test tee and a cleanout tee the port plug may be removed for the inspection of the interior of the piping system and for insertion of apparatus for cleaning the system and removal of obstructions.

Embodiments of test tees also have the advantage of avoiding the safety hazard associated with the failure of a balloon plug which retains water at 15 psi. Spillage inside the chase is avoided, thereby reducing the incidence of mold in the between-walls chase. The replacement costs associated with balloon seals is avoided; as is leakage associated with sliding seals. Test tee embodiments function as conventional cleanout tees when testing is not required. In fact, the access port of the test tee is larger than a typical access port of a cleanout tee. This is because the test tee access port must be large enough to accommodate the test plug. The larger access port also allows easier hand access for inspection and cleaning than does the smaller access ports associated with conventional cleanout tees.

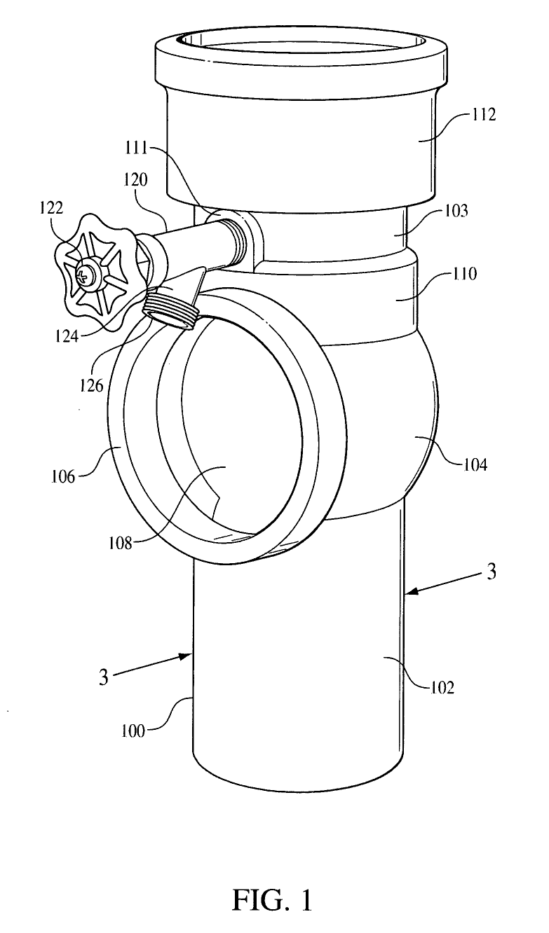

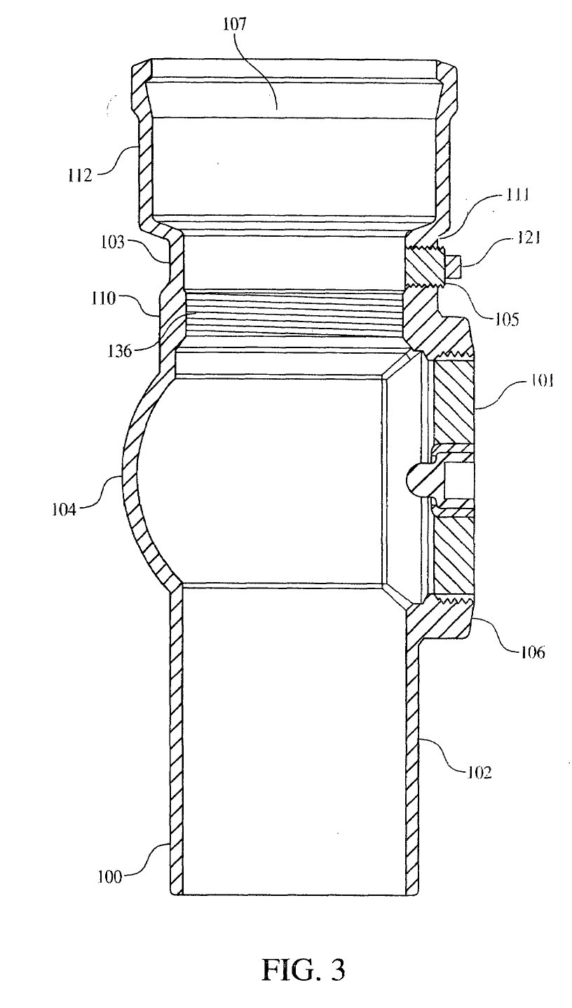

FIG. 1 is a perspective view of one embodiment test tee. Visible at the top of the test tee 100 is a connector bell 112, connected to a barrel 103, which is at the top of the expanded chamber 104, which is above the outlet pipe 102. An access port 108 is located on the side of the chamber 104. An access port flange 106 is threaded on the inner circumference to interact with an access port plug (not shown in FIG. 1, 100 in FIG. 3) which is threaded about its outer circumference. A flange 110 at the top of the chamber runs around the barrel. A flange extension 111 extends from the access port flange 106 to the bottom of the connector bell 112.

The flange extension 111 is penetrated by a threaded test port (not shown in FIG. 1, 106 in FIG. 3). A threaded nipple 120 is engaged with the test port. A valve 120 controls flow of water through the nipple 120. A spigot 124 is attached to the side of the nipple 120, and the end of the spigot is threaded 126 to accommodate a hose connector.

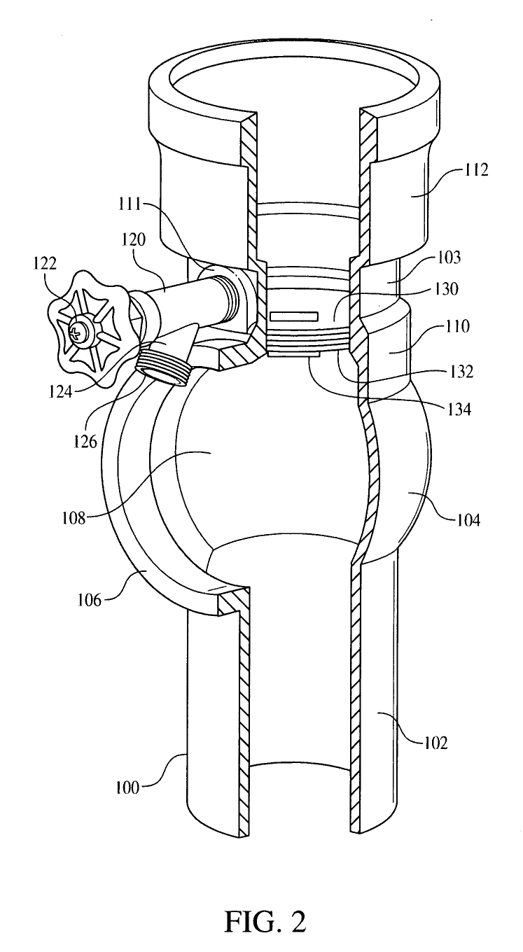

FIG. 2 is a perspective view of a partial section of an embodiment test tee. Visible at the top of the test tee 100 is a connector bell 112, connected to a barrel 103, which is at the top of the expanded chamber 104, which is above the outlet pipe 102. An access port 108 is located on the side of the chamber 104. An access port flange 106 is threaded on the inner circumference to interact with an access port plug (not shown in FIG. 2, 101 in FIG. 3) which is threaded about its outer circumference. A flange 110 at the top of the chamber runs around the barrel. A flange extension 111 extends from the access port flange 106 to the bottom of the connector bell 112.

The flange extension 111 is penetrated by a threaded test port (not shown in FIG. 2, 106 in FIG. 3). A threaded nipple 120 is engaged with the test port. A valve 120 controls flow of water through the nipple 120. A spigot 124 is attached to the side of the nipple 120, and the end of the spigot is threaded 126 to accommodate a hose connector.

A test plug 130 is shown engaged with attachment facilities on the internal surface of the barrel above the access port 108. In this embodiment the attachment facilities are a threaded surface on the internal surface of the barrel (not shown in FIG. 2) which removably engages with threaded circumference 132 of the test plug 130. A raised hex head 134 is used to tighten and loosen the test plug in place. In other embodiments the attachment facilities are a bayonet lock structure on the internal surface of the barrel which removably engages with a bayonet lock structure on the circumference of the test plug. The diameter of the access port 108 is large enough to allow passage of the test plug 130 into the chamber 104 so the test plug can be placed in position to close the lumen of the barrel, and, when testing is completed, to remove the test plug from the chamber.

FIG. 3 is a cross section of an embodiment test tee taken at line 3-3 of FIG. 1 but with access port plug 101 and test port plug 121 in place. Visible at the top of the test tee 100 is a connector bell 112, connected to a barrel 103, which is at the top of the expanded chamber 104, which is above the outlet pipe 102. An access port (filled by access port plug 101) is located on the side of the chamber 104. An access port flange 106 is threaded on the inner circumference to interact with an access port plug 101 which is threaded about its outer circumference. A flange 110 at the top of the chamber runs around the barrel. A flange extension 111 extends from the access port flange 106 to the bottom of the connector bell 112. Visible in FIG. 3 is the threaded 136 surface on the internal surface of the barrel which interacts with the threaded circumference of the test plug when it is desired to close the lumen 107 of the test tee for a hydrologic test.

The flange extension 111 is penetrated by a threaded test port 105. An optional threaded test port plug 121 is shown in place in the test port in FIG. 3. The test port plug 121 is removed and replaced by a nipple with valve and spigot (shown in FIG. 1) when it is desired to do a hydrologic test.

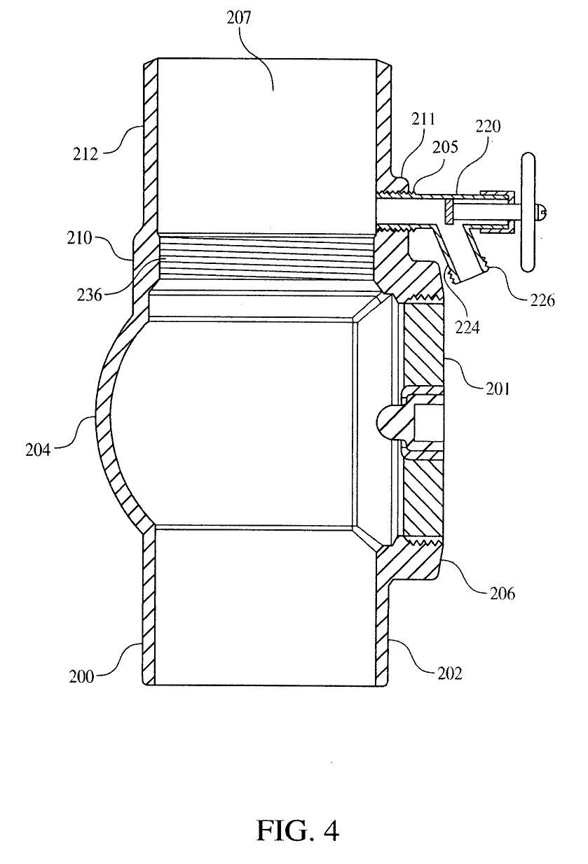

FIG. 4 is a cross section of a second embodiment test tee 200. The second embodiment is a no-hub tee with connector hub at either end. An inlet barrel 212 is at the top of the expanded chamber 204, which is above the outlet pipe 202. An access port is located on the side of the chamber 204 and is filled by access port plug 201 in FIG. 4. An access port flange 206 is threaded on the inner circumference to interact with an access port plug 201 which is threaded about its own circumference. A flange 210 at the top of the chamber runs around the barrel. A flange extension 211 extends from the access port flange 206 to the middle of the inlet barrel 212. Visible in FIG. 4 is the threaded 236 surface on the internal surface of the barrel which interacts with the threaded circumference of the test plug when it is desired to close the lumen 207 of the test tee for a hydrologic test.

The flange extension 211 is penetrated by a threaded test port 206. A threaded nipple 220 is engaged with the test port 205. A valve 220 controls flow of water through the nipple 220. A spigot 224 is attached to the side of the nipple 220, and the end of the spigot is threaded 226 to accommodate a hose connector.

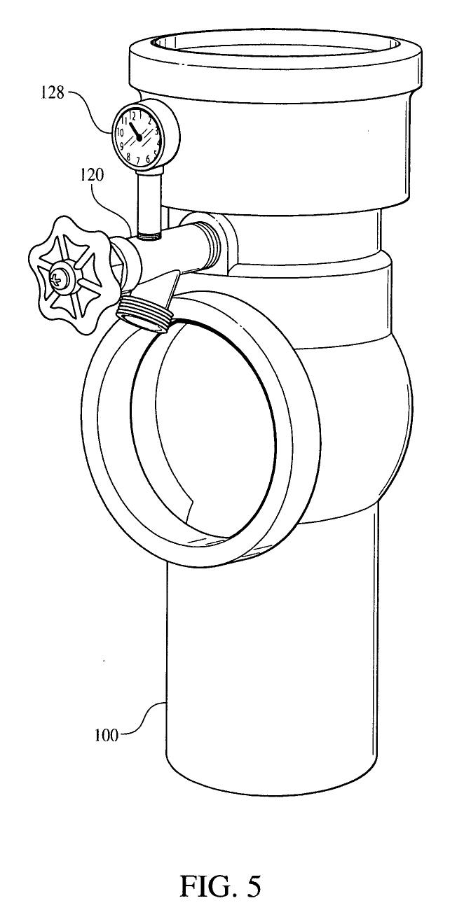

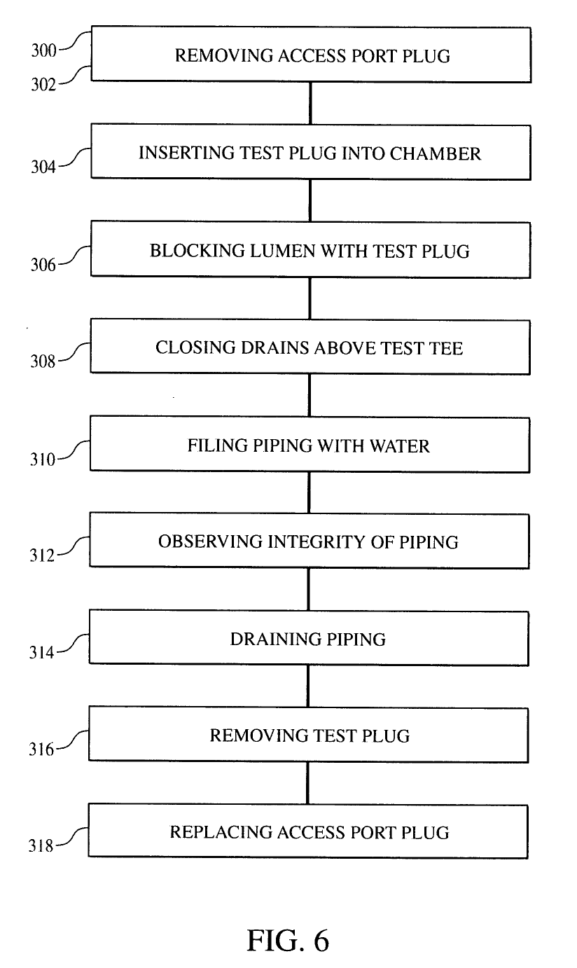

FIG. 5 is a perspective view of an embodiment test tee 100 of FIG. 1 with a pressure gauge 128 attached to the nipple 120.

FIG. 6 is a diagrammatic depiction of the process 300 of using an embodiment test tee to determine the integrity of a piping system.

The first step 302 involves removing the access port plug by unscrewing the port plug.

In the second step 304 a threaded test plug is then inserted through the test port into the chamber.

In the third step 306 the test plug is engaged with the threaded lumen of the test tee, thereby blocking the lumen.

In the fourth step 308 drains and other openings in the portion of the piping above the test tee to be tested are closed.

In the fifth step 310 piping above the test tee is filled with water. A nipple with a valve, and a spigot with a hose attachment attached may advantageously be used to fill the piping above the tee with water. The valve is opened, water is admitted into the piping by a hose attached to the nipple, and the valve is closed when the water has reached the desired level. Alternatively, other water sources above the test tee may be used to fill the piping with water when the nipple valve is closed or a test port plug is in place instead of a nipple.

In the sixth step 312 the water level in the filled piping is observed for a predetermined duration of time to insure the integrity of the piping above the test tee. A suitable duration of time is fifteen minutes. One method of observing the water level is to visually note the water level at the highest portion of the piping being tested at the beginning and at the end of the observation period. Another method is to use a nipple with an attached pressure gauge and to note the pressure of the water at the beginning and end of the observation period. The absence of a significant drop in water level or significant drop in pressure over the observation period indicates the integrity of the piping above the test tee.

In the seventh step 314 the water is drained from the test tee by opening the valve on the nipple or by removing the test port plug with caution. The water may be conveyed from the test tee by a hose attached to the hose attachment on the spigot. This avoids any chance of water spillage, and is particularly advantageous when the test tee is located in a chase, as is the usual case.

In the eighth step 316 the test plug is unscrewed from the barrel of the test tee and is removed from the test tee through the access port.

In the ninth step 318 the access port plug is replaced. The test tee now may be used as a cleanout tee.

After a test is completed, the nipple can be replaced with a test port plug if desired. It is advantageous to use a single nipple with associated valve and spigot with a number of test tees because the cost of a test port plug is less than that of a nipple with associated valve and spigot.

Embodiments include a number of pipe diameters, such as 3 inch, 4 inch, and 6 inch pipes. For example, in the 6 inch size embodiment, the diameter of the hub and of the outlet pipe is 6 inches, the diameter of the access port is 6 inches, and the diameter of the threaded inner surface of the barrel and of the test plug is 5 inches. The diameter of the test port is ½ inch. The length of this embodiment from hub connector to outlet pipe is 17 inches. Embodiments in other sizes are contemplated.

All components of embodiments of test tees are manufactured of strong, durable, inexpensive materials, such as cast iron, steel, or bronze.

While a number of exemplary aspects and embodiments have been discussed above, those of skill in the art will recognize certain modifications, permutations, additions and subcombinations thereof. It is therefore intended that the following appended claims and claims hereafter introduced are interpreted to include all such modifications, permutations, additions and sub-combinations as are within their true spirit and scope.

I claim:

1. A hydrologic test tee for a piping system comprising:
a cleanout tee having an inlet,
the inlet attached to a barrel,
the barrel having an expanded chamber,
an access port on the side of the chamber,
an access port plug,
attachment facilities on the internal surface of the barrel above the access port,
a test plug capable of reversible interaction with the attachment facilities on the barrel,
the test plug capable of blocking the lumen of the piping system,
a test port located on the barrel above the attachment facilities, and
an outlet located below the chamber.

2. The hydrologic test tee of claim 1 further comprising:
a nipple inserted into the test port, and
a valve controlling flow of water through the nipple.

3. The hydrologic test tee of claim 2 further comprising:
a pressure gauge attached to the nipple.

4. The hydrologic test tee of claim 2 further comprising:
a spigot attached to the nipple.

5. The hydrologic test tee of claim 4 further comprising a hose connection on the spigot.

6. The hydrologic test tee of claim 1 further comprising:
a flange on the outside of the tee above the test plug, the test port located on the flange.

7. The hydrologic test tee of claim 1 wherein the attachment facilities on the barrel lumen comprise a threaded surface and the attachment facilities on the test plug comprise a threaded circumference.

8. The hydrologic test tee of claim 1 wherein the attachment provisions on the piping surface comprise a bayonet connector and the attachment facilities on the test plug comprise a bayonet connector.

9. The hydrologic test tee of claim 1 wherein the test plug is capable of being inserted through the access port.

10. The hydrologic test tee of claim 1 wherein the piping system comprises drainage, waste, or vent piping.

11. The hydrologic test tee of claim 1 comprised of cast iron, steel, or bronze.

12. A hydrologic test tee for a piping system comprising:
an inlet having a bell at the upper end,
a barrel below the inlet,
a chamber below the barrel,
an access port located on the side of the chamber, the circumference of the access port having a threaded surface,
an access port plug, the plug having a threaded circumference capable of interacting with the threaded circumference of the access port,
a threaded surface on the internal surface of the barrel at the top of the chamber,
a test plug test plug having a threaded circumference capable of interaction with the threaded internal surface of the barrel,
the test plug capable of passing through the access port into the chamber, the test plug capable of blocking the lumen of the barrel when attached to the threaded surface of the barrel,
a test port located on the barrel above the threaded surface,
a nipple inserted into the test port,
a valve controlling fluid flow through the nipple, and
a spigot having a hose connector attached to the nipple.

13. The process of hydrologic testing of a piping system using a test tee having an inlet, a barrel, a chamber, an access port, an outlet, comprising the steps:
a. removing the access port plug,
b. inserting a test plug into the chamber,
c. closing the lumen of the barrel with the test plug,
d. closing all drains in the piping system located above the test tee,
e. filling the piping above the test plug with water to the highest point in the piping system,
f. observing the water level in the piping at the beginning and at the ending of a predetermined period of time,
g. concluding that the piping system above the test tee has integrity if there is no significant difference between the two water level observations,
h. draining the water out of the piping,
i. removing the test plug from the lumen of the barrel and the chamber, and
j. replacing the access port plug.

14. The process of claim 12 wherein the piping system is filled with water and drained of water through a nipple in the test port.

15. The process of claim 12 wherein the observation of the water level in the piping is accomplished using a pressure gauge inserted in the test port or inserted in the nipple in the test port.

16. The process of claim 12 wherein the observation of the water level in the piping is accomplished by visual observation of the level of water at the highest point in the piping system.
